(19) United States
(12) Patent Application Publication
(10) Pub. No.: US 2002/0117996 A1
(43) Pub. Date: Aug. 29, 2002

(54) Battery charger for a cellular phone

(76) Inventor: Chin-Hung Cheng, Chungho (TW)

Correspondence Address: JACOBSON, PRICE, HOLMAN & STERN, PROFESSIONAL LIMITED LIABILITY COMPANY, 400 Seventh Street, N.W., Washington, DC, 20004, US

(21) Appl. No.: 09/793,763

(22) Filed: Feb. 27, 2001

(51) Int. Cl. H02J 7/00

(52) U.S. Cl. 320/114

(57) ABSTRACT

A battery charger for cellular phone comprises a holder with a cellular phone port, a contact terminal on the cellular phone port and a circuit board with charging circuitry tied to the connector. The battery of cellular phone can be charged while cellular phone is in the cellular phone port. One bendable stretching arm is respectively mounted on both upper side of the holder, users can adjust the bendable stretching arms to fit different kinds of cellular phones based on different sizes. One LED indicator at the end of each bendable stretching arm is used as an indication for end of battery charging and incoming calls. A power cord can be arranged around the winding reel for smaller size, thereby making the whole charger easier to for storage and carrying.

### BACKGROUND OF THE INVENTION

I. Field of the Invention

This invention relates generally to a battery charger for a cellular phone and, more specifically, to a battery charger for a cellular phone that charges the battery of a cellular phone while the cellular is in stand-by mode. The LED indicators on the battery charger indicate different statuses: completion of battery charging or incoming phone. A winding reel on the bottom of holder makes power cord easy for use and storage.

II. Description of the Prior Art

With the availability of cellular phone, almost everyone has a cellular phone; therefore, anybody can be reached anywhere and anytime. It is very convenient. The cellular phone has battery as power source, and battery must be charged when out of power or the cellular phone is useless. However, most of the batteries, when charged, have to be removed from cellular phone first and placed on the battery charger, and the cellular phone is unusable at that time unless a backup battery is applied. While indoors, the cellular phone is generally placed on desk, users tend to forget its whereabouts. It is more convenient to have a small rack especially for the cellular phone. Most of the racks for the cellular phone are without battery charger, if battery power wears out and not known, users might miss important calls.

Power cord of cellular phone battery charger is normally a straight wire, it needs to be folded or wound into smaller size for storing and moving around. However, general users will just put the battery charger and power cord into a drawer such that the power cord is easily commingled with others that cause mess and inconvenience when it is taken out next time.

### SUMMARY OF THE INVENTION

It is therefore a primary object of the invention to provide a battery charger for a cellular phone comprising a holder with a cellular phone port, a contact terminal on the cellular phone port, a circuit board with charging circuitry tied to the connector. The battery of cellular phone can be charged while cellular phone is in the cellular phone port.

It is another objective of this invention to provide a battery charger for a cellular phone with one bendable stretching arm on both upper side of the holder while users can adjust the bendable stretching arms to fit different kinds of cellular phones based on different sizes. One LED indicator is fitted to the end of each bendable stretching arm for indication of completion of battery charging and incoming calls.

It is still an objective of this invention to provide a battery charger for cellular phone containing a winding reel at the bottom of holder, power cord can be arranged around the winding reel for smaller size makes the whole charger easier to store and carry.

### BRIEF DESCRIPTION OF THE DRAWINGS

The accomplishment of the above-mentioned object of the present invention will become apparent from the following description and its accompanying drawings which disclose illustrative an embodiment of the present invention, and are as follows:

FIG. 1 is a perspective view of the present invention;

FIG. 2 is a cross-sectional view of an embodiment of the present invention; and

FIG. 3 is a physical illustration of the present invention.

### DESCRIPTION OF THE PREFERRED EMBODIMENT

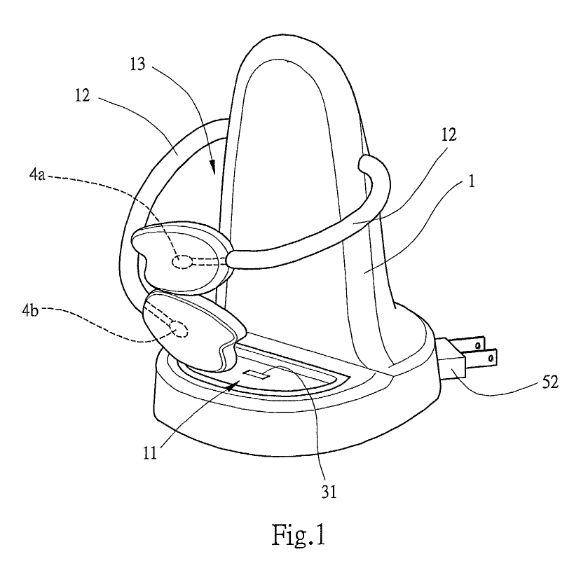

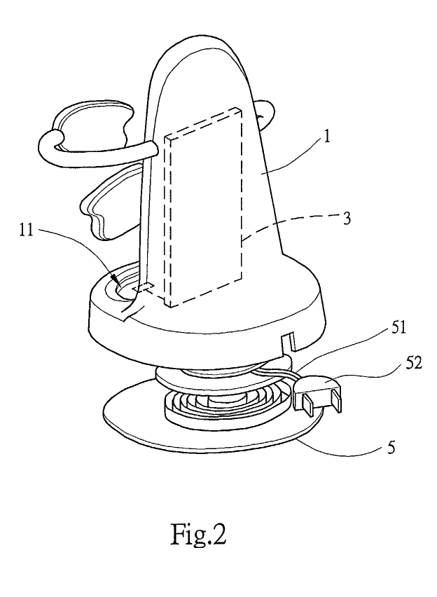

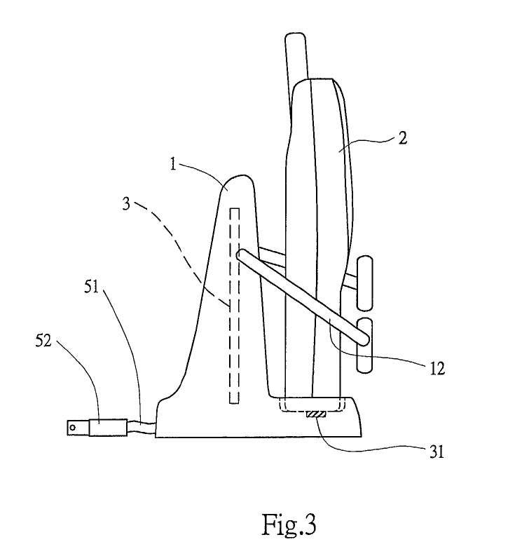

Referring to FIG. 1 and FIG. 2, the present invention is composed of a holder 1, a cellular phone port 11, a bendable stretching arm 12 on both upper sides of holder 1; the two bendable stretching arm 12 form a receiving space 13 for cellular phone 2, as shown on FIG. 3. A circuit board 3 is inside holder 1 containing battery charging circuitry, incoming call sensing circuitry and signal processing circuitry. The cellular phone port 11 mentioned above has a contact terminal 31 which is connected to battery charging circuitry and signal processing circuitry on the circuit board 3. Two LED indicators 4a and 4b also connected to the circuit board 3 are placed on the end of two stretching arm 12. A winding reel 5 is equipped on the bottom of holder 1; a main power cord 51 is connected to circuit board 3 and wound on the winding reel 5 at the bottom of the holder 1.

Based on above description, it is very easy to charge the battery, first place cellular phone 2 to the contact terminal 31 of cellular phone port 11, plug in the plug 52 of main power cord 51 to power outlet (not shown). The cellular phone 2 in stand-by mode can remain on the base 1 for charging so that the battery won't be worn out.

The two stretching arm 12 on base 1 are bendable, there they can be adjusted for different kinds of cellular phone 2. The LED indicators 4a and 4b connected to and controlled by circuit board 3 can light up (not flash) when finish battery charging to remind the users. The LED indicators 4a and 4b also connect to the incoming call sensing circuitry on the circuit board 3. When the cellular phone 2 receives incoming call, the LED indicators 4a and 4b flash to remind the users. The color of the light for incoming calls is different from that for finishing charging. A power cord 51 can be arranged around to the winding reel 5 on the bottom of the holder 1 for smaller size, thereby making the whole charger easier for storage and carrying.

While a preferred embodiment of the invention has been shown and described in detail, it will be readily understood and appreciated that numerous omissions, changes and additions may be made without departing from the spirit and scope of the invention.

What is claimed is:

1. A battery charger for a cellular phone comprising:
a holder having a cellular phone port while two bendable stretching arms are disposed above said cellular phone port on said holder 1, thereby forming a receiving space for said cellular phone;
a circuit board disposed inside said holder and provided with a battery charging circuitry, an incoming call sensing circuitry and a signal processing circuitry while said cellular phone port has a contact terminal which is connected to said battery charging circuitry and said signal processing circuitry; and
two LED indicators connected to said charging circuitry and said signal processing circuitry of said circuit board and installed at the end of each said bendable stretching arm for indication of completion of battery charging and incoming calls;
a winding reel located at the bottom of said holder, power cord connected to said circuit board being wound on said winding reel so that said power cord is collected in a wound way to the bottom of said holder.
